(19) United States
(12) Patent Application Publication
(10) Pub. No.: US 2015/0039501 A1
(43) Pub. Date: Feb. 5, 2015

(54) Supplier Using A Buyer-Initiated Payment System To Provide Qualifying Information To Obtain An Interchange Rate

(71) Applicant: Bora Payment Systems, LLC, Walnut Creek, CA (US)

(72) Inventor: Steven D. Evans, Hercules, CA (US)

(73) Assignee: Bora Payment Systems, LLC, Walnut Creek, CA (US)

(21) Appl. No.: 14/279,914

(22) Filed: May 16, 2014

Related U.S. Application Data
(60) Provisional application No. 61/860,840, filed on Jul. 31, 2013.

(51) Int. Cl. G06Q 20/10; G06Q 20/34; G06Q 20/24

(52) U.S. Cl. CPC G06Q 20/102; G06Q 20/24; G06Q 20/34
USPC 705/40

(57) ABSTRACT

A supplier uses a Buyer-Initiated Payment (BIP) system, such as a Payer Direct Hub (PDH), to obtain a selected interchange rate to charge the supplier. The payer may use a Supplier-Initiated Payment (SIP) system or manual method to provide a commercial credit card number to a supplier. A supplier may log onto a BIP system and enter the number along with the payment amount. A BIP system determines whether the entered information includes the qualifying information to obtain the selected interchange rate for the supplier. The qualifying information for a selected interchange rate may include tax information or additional line item detail information. Substitute information to be used as the qualifying information needed for the selected interchange rate is retrieved. The BIP system combines the retrieved substitute information with the entered information and outputs credit card transaction information so that the supplier is paid using the selected interchange rate.

### CLAIM OF PRIORITY

This application claims priority from U.S. Provisional Patent Application No. 61/860,840, entitled “SUPPLIER-INITIATED PAYMENTS—LEAST COST INTERCHANGE FOR B2B PURCHASE CARD PAYMENTS,” by Steven D. Evans, filed Jul. 31, 2013, incorporated by reference herein in its entirety.

### BACKGROUND

Buyer-Initiated Payment (BIP) systems often use commercial credit cards, such as purchase cards (or Pcards or P-cards), for automated Accounts Payable (AP) payments. Typically, a payer pays a supplier by sending an AP payment file to a BIP system. A BIP system may route a payment either directly to a supplier's acquirer processor or through an acquirer gateway (such as PayPal's PayFlowPro) to a supplier's acquirer processor. A supplier's acquirer processor then may forward an authorization request to a card network (such as Visa or MasterCard) that in turn forwards the request to the issuer bank's issuer processor (such as Total System Services (Tsys) or First Data Corporation (FDC)). If the authorization request is authorized, an acquirer processor sends a consolidated settlement request later the same day for card networks to settle the credits and debits between a merchant bank (supplier's bank who may be partnered with an acquirer processor) and an issuer bank (payer's bank who may be partnered with an issuer processor).

A payee typically pays a fee when agreeing to receive payments via a commercial credit card. The fee is typically in the form of a percentage of the payment amount received from the payer. The percentage deducted from the payee's payment amount may range from approximately 2% to approximately 3%. The fee may include fees charged by a card network (interchange fee), acquirer processor (acquirer fee) and a credit card company, such as Visa or MasterCard (credit card company assessment). The combined total fee charged is often referred to as “Discount Fee.”

### SUMMARY

A supplier uses a Buyer-Initiated Payment (BIP) system, such as a Payer Direct Hub (PDH), to obtain missing qualifying information for a selected interchange rate to charge the supplier. A supplier (or buyer) may select an interchange rate that the supplier is charged when receiving monies owed from the buyer. A supplier (or buyer) may select from interchange fees or rates associated with Level 1, Level 2 and Level 3 (or automatically Large Ticket (LT) when the payment amount exceeds a threshold amount) rates. After a buyer (or payer) receives an invoice, the buyer may use a Supplier-Initiated Payment (SIP) system or manual method to provide a card number to a supplier. A supplier may then log onto a BIP system and enter the card number along with the payment amount. A BIP system determines whether the entered information includes the qualifying information to obtain the selected interchange rate for the supplier. The qualifying information for a selected interchange rate may include tax information or additional line item detail information. Missing qualifying or substitute/fabricated information for the selected interchange rate is retrieved. The BIP system combines the retrieved qualifying information with the entered information and outputs credit card transaction information so that the supplier is paid using the selected interchange rate.

One aspect of the present technology includes a method for a supplier to use a PDH to obtain qualifying information for a selected interchange rate. The method comprises a supplier (payee) providing an invoice to a buyer. The buyer (payer) then provides a card number to the supplier (by way of a SIP system or manually). The PDH receives entered payee information that includes the card number and a payment amount from the supplier. The PDH determines whether the payee information includes qualifying information. When qualifying information is missing, the PDH retrieves the missing qualifying information for a selected interchange rate of the supplier. The PDH then outputs transaction information (including the missing qualifying/fabricated information) to an acquirer processor that outputs an authorization and settlement request to a network, such as a credit card network.

According to another aspect of the present technology, a method is provided for a supplier to operate a BIP system. The method comprises providing a user interface to select an interchange rate, from a plurality of interchange rates, to be charged to the supplier. The selected interchange rate is stored in processor readable memory of the BIP system. The BIP system receives, from the supplier, a payee information that includes a card number and a payment amount to pay the supplier. The BIP system determines whether the payee information includes qualifying information. When the payee information does not include qualifying information, qualifying information is retrieved in response to the selected interchange rate. The BIP system then outputs transaction information to pay the supplier the payment amount, wherein the transaction information includes the card number, payment amount and qualifying information.

According to still another aspect of the present technology, a method is provided for a supplier to operate a BIP system. The method comprises providing a user interface, by the BIP system, to select an interchange rate, from a plurality of interchange rates, to be charged to the supplier. The selected interchange rate is stored in processor readable memory of the BIP system. An invoice is provided to a buyer from a supplier. A card number associated with a commercial credit card is provided to the supplier from the buyer (by way of a SIP system or manually). The BIP system receives from the supplier, payee information that includes the card number and a payment amount to pay the supplier. The BIP system determines whether the payee information includes qualifying information. Missing qualifying information (substitute/fabricated information) is retrieved from the processor readable memory in response to the selected interchange rate. The BIP system outputs transaction information to pay the supplier the payment amount, wherein the transaction information includes the card number, payment amount and missing qualifying information.

### BRIEF DESCRIPTION OF THE DRAWINGS

FIG. 1 depicts a block diagram illustrating one embodiment of a system including a BIP system;

FIG. 2 depicts a block diagram illustrating one embodiment of a BIP system hardware and software architecture;

FIG. 3 illustrates Tables I that shows exemplary levels of fees or rates charged to payees that accept credit card payments that have different interchange rates;

FIG. 4 illustrates exemplary information, such as payee information, which may be provided by a payee (or payer in an alternate embodiment) to a BIP system;

FIG. 5 depicts an exemplary user interface having a screen showing substitute/fabricated information for qualifying information, such as line item detail information, in order to obtain a selected interchange rate;

FIG. 6 depicts an exemplary user interface having a screen for selecting an interchange rate to charge a payee;

FIG. 7 depicts an exemplary user interface having a screen that allows a payee to select different interchange rates to be charge by different payers;

FIG. 8 depicts a flow diagram displaying an exemplary method of providing qualifying information to obtain a selected interchange rate to charge a payee in a credit card transaction;

FIG. 9A depicts a flow diagrams displaying an exemplary method of providing qualifying information to obtain selected interchange rates for different payees in credit card transactions;

FIG. 9B depicts a flow diagrams displaying an exemplary method of providing substitute information for the qualifying information, such as line item detail and tax information, to obtain selected interchange rates for different payees in credit card transactions;

FIGS. 9C-E depict flow diagrams displaying exemplary methods of suppliers using a BIP system, such a PDH.

FIG. 10 depicts a block diagram illustrating one embodiment of a BIP system;

FIG. 11 depicts an exemplary user interface for paying a payee in a BIP system shown in FIG. 1;

FIG. 12 depicts a block diagram illustrating one embodiment of a supplier using a BIP system to provide qualifying information to obtain a selected interchange rate to be charged.

### DETAILED DESCRIPTION

A supplier uses a BIP system, such as a PDH, to obtain missing qualifying information for a selected interchange rate to charge the supplier when receiving a commercial credit card payment. A supplier (or payer) may select an interchange rate that the supplier is charged when receiving monies owed from the buyer by way of a commercial credit card (such as a Pcard or P-card) of the buyer. A supplier (or payer) may select from interchange rates associated with Level 1, Level 2 and Level 3 (or automatically Large Ticket (LT) when the payment amount exceeds a threshold amount) rates.

After a payer receives an invoice, the payer may use a SIP system or manual method to provide a commercial credit card number to a supplier (payee). A supplier may then log onto a BIP system and enter payee information, such as a commercial credit card number along with the payment amount. A BIP system then determines whether the entered information includes the qualifying information (such as specific transaction data) to obtain the selected interchange rate for the supplier. The qualifying information for a selected interchange rate may include tax information or additional line item detail information (such as invoice number, quantity and description, such as Stock Keeping Unit (SKU)). Missing qualifying or substitute/fabricated information for the selected interchange rate is retrieved from a processor readable memory. The BIP system combines the retrieved qualifying (or substitute/fabricated) information with the entered information and outputs credit card transaction information so that the supplier is paid using the selected interchange rate. In an embodiment, the credit card transaction information is outputted to a supplier's acquirer processor, which then outputs credit card transaction information to a credit card network in order to provide the payment amount to a supplier's bank.

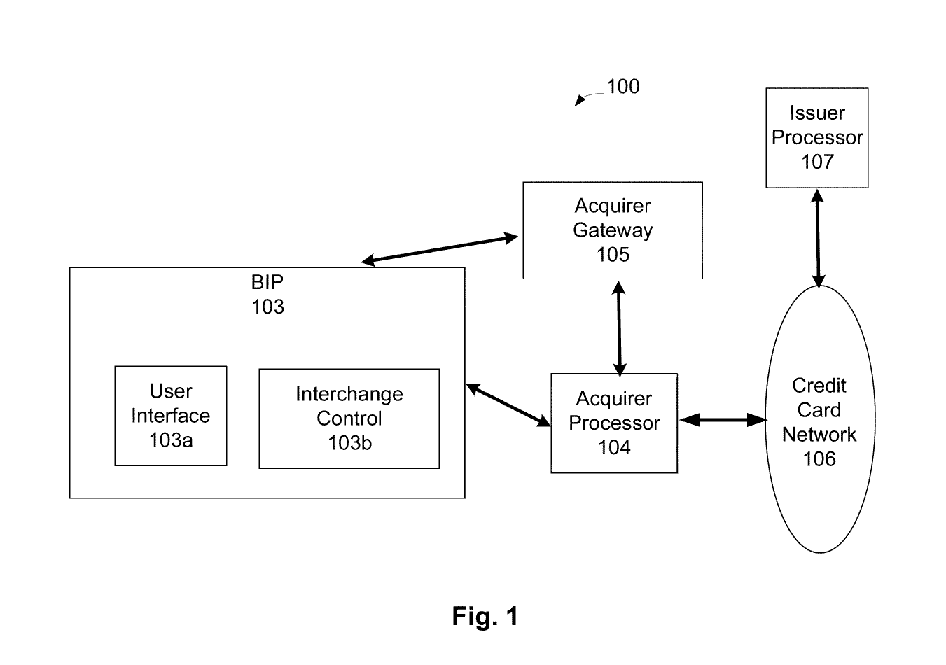

FIG. 1 depicts a block diagram illustrating one embodiment of a system 100 having a BIP system 103 that facilitates commercial credit card transactions. BIP system 103 enables a user (payee or payer) to select an interchange rate to charge a payee when paying, by way of a commercial credit card, the payee monies owed by a payer. BIP system 103 determines whether payee information that may be provided by a payee (or payer) has qualifying information (or data) so that a selected interchange rate may be charged to a payee. BIP system 103 then provides missing qualifying information (or substitute or fabricated information) into a commercial credit card authorization request or transaction so that the payee pays the selected interchange rate. The commercial credit card transactions may include using a commercial credit card, such as a Pcard or other Business-to-Business (B2B) credit cards.

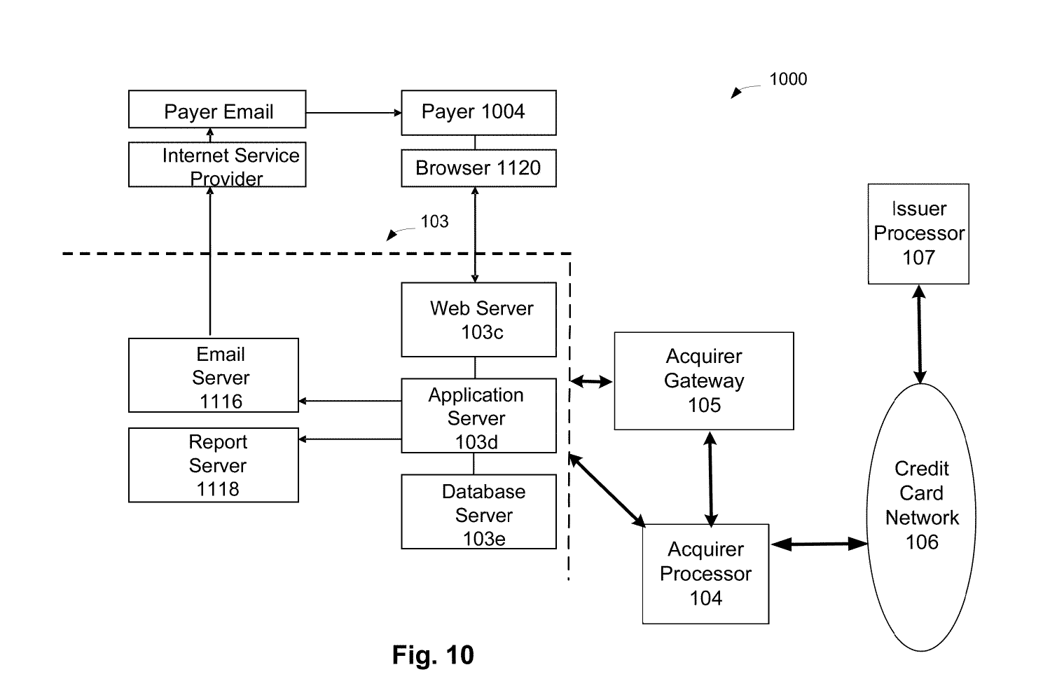

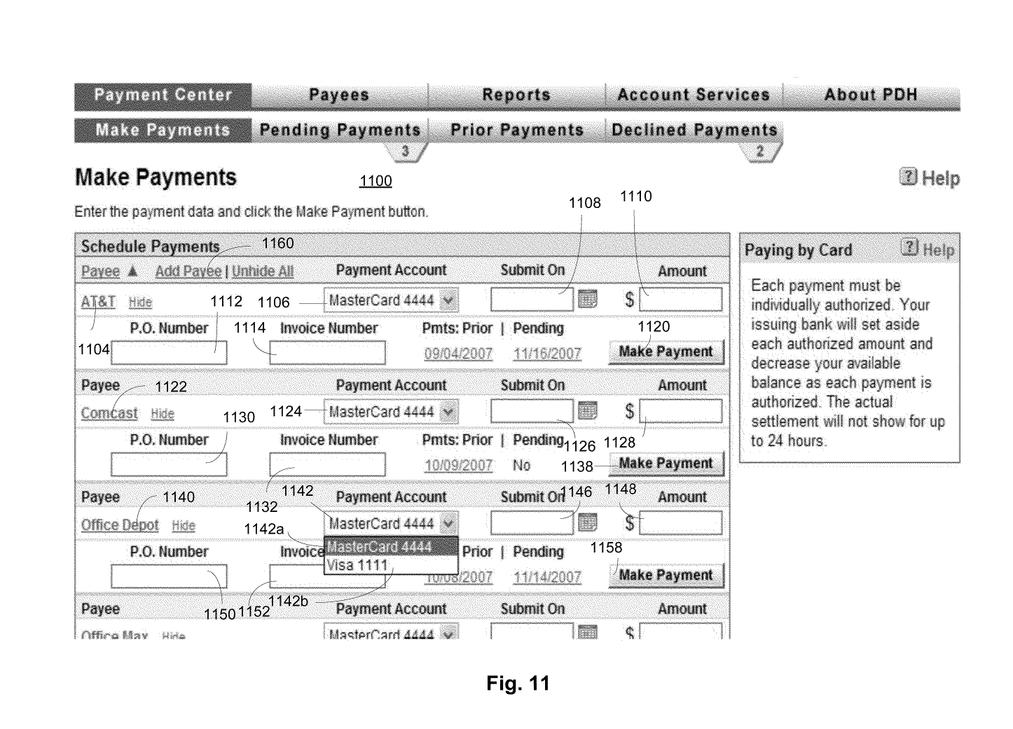

BIP systems 103 makes commercial credit card payments by routing credit card authorization or payment requests to an acquirer processor 104. In an alternate embodiment, credit card payment requests may be routed to a gateway, such as acquirer gateway 105 as described herein. Acquirer processor 104 then communicates with credit card network 106 (such as Visa, MasterCard, AMEX credit card network) to complete the commercial credit card transaction as described herein. As one of ordinary skill in the art would understand, a BIP system may include Straight-Through Processing (STP), MasterCard's Payment Gateway (MPG) or a “push” payment system where a payee (supplier or merchant) is removed from payment origination. In an embodiment, BIP system 103 is a Payer Direct Hub (PDH) as illustrated in FIGS. 10-11 and described herein.

An issuer processor 107, in an embodiment, refers to a service company that performs issuer bank functions, such as providing a commercial credit card with predetermined parameters or spending limits. In an embodiment, an issuer processor 107 and/or issuer bank may be electronically coupled to credit card network 106.

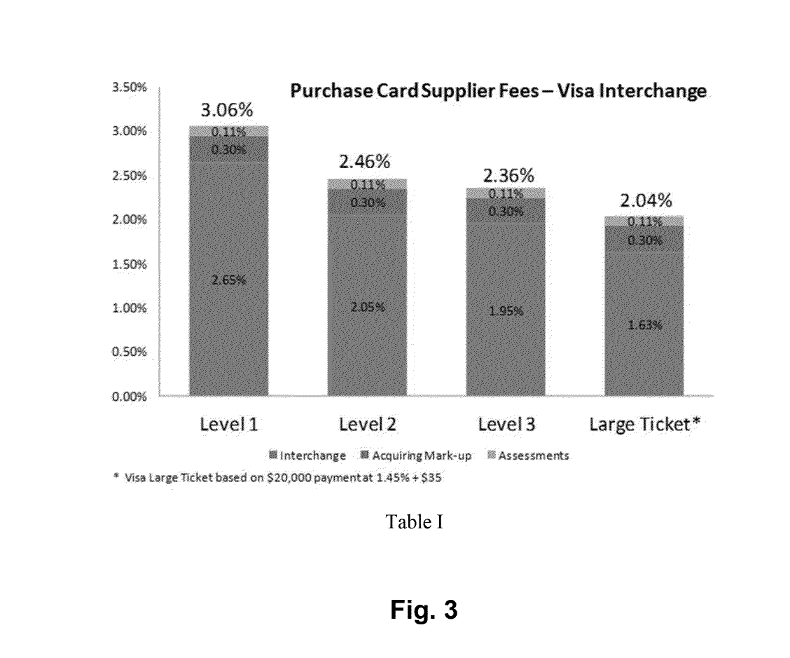

Payees are charged a fee for accepting a commercial credit card payment. The total payee fee consists of three components: 1) Interchange rate (fee charged by credit card networks and provided to a bank issuer); 2) Acquiring mark-up (fee charged by acquirer processor); Network assessments (fee charged by Visa, MasterCard, AMEX, or other credit card network). Table I of FIG. 3 illustrates the total payee fee a payee would pay under difference Visa Pcard interchange rates. The network assessments is approximately 11 basis points in Table I. The acquiring mark-up is negotiated between a payee and an acquirer processor or merchant bank. For example, Table I illustrates an acquiring mark-up of 30 basis points. A total payee fee is often referred to as a “Discount Fee.”

As Table I further illustrates, the interchange rates vary between a Level 1 (L1) rate at 2.65% and standard Large Ticket (LT) rate which is 1.35%+$40 for MasterCard and 1.45%+$35 for Visa. There is a significant cost or fee reduction to a payee when receiving a commercial credit card payment at an L3 or LT rate compared to a L1 rate. For example in a $20,000 transaction, the cost difference to a payee is $204 (20,000*3.06%−20,000*2.04%). Unless a BIP system can obtain a LT rate, a payee will typically pay at least an extra 1% interchange rate (L1 rate) to receive a payment by commercial credit card. Over the course of a year, a large payee's accounts receivable (A/R) costs will be hundreds of thousands of dollars more due to a higher level of interchange fees paid to receive payments.

The interchange rate level is determined by an amount of information (or data) provided with a commercial credit card transaction as well as an amount of the transaction in the case of a LT rate. To obtain a L2 rate that is lower than the L1 rate, tax information is included with a transaction (or payment) amount. The tax information may include the total tax paid or sales tax on the transaction. To obtain a lower L3 rate than the L2 rate, additional line item detail information such as invoice number, quantity, and description (such as SKU) is also included with the tax information. To qualify for a LT rate, tax information and line item detail information is included as well as the payment amount is greater than a predetermined LT threshold amount, such as $6,880 for Visa and $7,255 for MasterCard.

In an alternate embodiment, an interchange rate or fee may be a flat fee or fixed amount rather than a percentage of the monies owed a supplier.

Payers may receive interchange rebates when using particular commercial credit cards. Issuer banks, such as a Pcard issuers, rebate a significant portion of their interchange fee to a payer or payment aggregator as an incentive to use their commercial credit card as opposed to a competitor's card. Consequently, even though a lower fee may be desired by payees, it's often in the interest of an issuer bank and payer to maintain higher interchange rates since the two divide up the interchange fees. Large payers often receive more than 50% of the interchange fee. Since BIP systems introduce efficiency and eliminate labor and reconciliation costs, BIP system efficiency often trumps the benefit of the rebate if higher supplier adoption can be obtained with a BIP system that delivers transactions at the best interchange rate. Consequently, there is a delicate balance between rebate/interchange rate and payee acceptance of a BIP system.

Rebates vary widely among bank issuers and other firms whose branded card is issued by a bank issuer. Some bank issuers and other firms pay a maximum rebate and offset the cost by reducing the payment terms. Some companies in specific market segments prefer the benefit of cash float that comes with a longer payment term and are willing to accept lower rebates to extend their payable days if the commercial credit card has extended payment terms. Bank issuers also vary widely on how much they penalize a payer and reduce their rebate when L3 and LT payments grow in proportion to L1 payments.

Even though a BIP system 103 may be able to route a credit card transaction in order to obtain a best interchange rate, there are competing influences in the market whereby a payer or payment aggregator may want the credit card transaction to route at an L2 or L1 rate. If the payer or payment aggregator is advancing an early payment to a payee, the payee may be contractually willing to pay a higher interchange rate to receive an earlier payment. Further, payers and payment aggregators receive interchange rebates from bank issuers and the larger the interchange rate, the more rebate revenue they can earn. Consequently, some payees will accept a L1 rate if they can be paid in 10 days versus accepting an L3 or LT rate if they are paid in 30 days. If a BIP system that a payer (or payment aggregator) uses is able to control the interchange rate, a payer (or payment aggregator) can reach contractual agreement with a payee to deliver the transaction at a pre-determined interchange rate in accordance with early payment terms.

When Pcards were initially used at point-of-sale (POS) terminal locations, such as in retail stores, there was value to a payer collecting certain data, or qualifying information, about the transaction. In order to incent a payer into providing the qualifying information at the POS terminal device, the associations agreed to give payees better interchange pricing if they provided the qualifying information. If payees provided tax information, the lower L2 rate applied, and if the payees provided additional line item detail information, the L3 rate applied. If payees provided tax information, line item detail information and the transaction amount was greater than a predetermined LT threshold amount, the lower LT rate applied. However, most payments by commercial credit cards now originate from an invoice being paid out of an AP system. Since product information is carried on purchase orders and invoices that commonly reside in a payer's AP system, there is little value to the qualifying information since the payer already has the qualifying information in their AP system. However, the interchange rules still apply and the Authorization Origination party (person submitting the commercial card payment) must provide the qualifying information in order to get the lower rates. A BIP system 103 has the capability to detect or determine whether payee information includes qualifying information and retrieve (or substitute/fabricate) the qualifying information in order to qualify or obtain L2, L3, and LT (when the payment is large enough) rates. Since the qualifying information provides no value to either the payer or payee (both already have the information), the qualifying information is ignored in the settlement records provided by a issuing and acquirer processors.

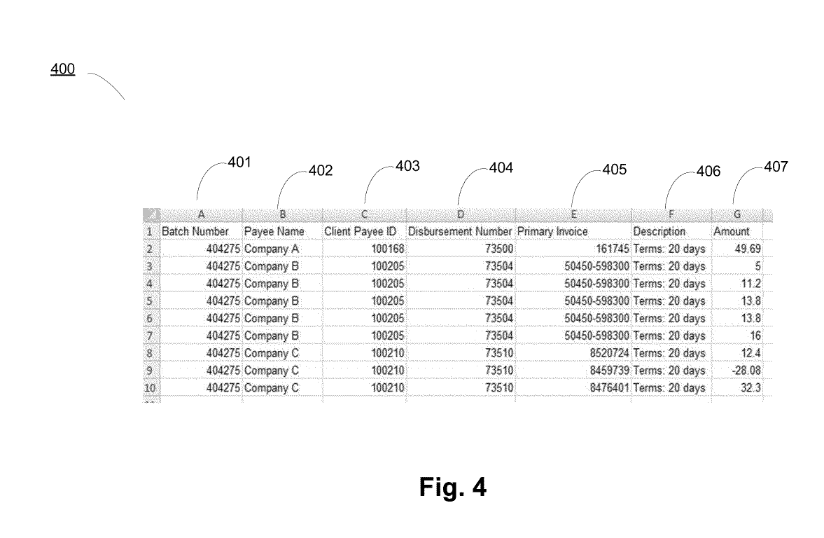

FIG. 4 illustrates exemplary information 400, such as payee information, which may be provided to a BIP system 103 by a payee (or payer in an alternate embodiment). In this alternate embodiment, information 400 may be provided by an AP system of a payer to a BIP system when a payer provides information 400. In an embodiment, information 400 may be included in an electronic file provided to a BIP system 103 from a payee or one or more payers or payment aggregators.

When a payee provides information 400 in an electronic file to a BIP system 103, information pertaining to that payee (such as lines 2-7 for “Company B” when the payee is Company B) is provided where other company payment information is not included or known by the payee (in this example, lines 2-7 are provided to a BIP system 103 by the Company B payee and lines 1 and 8-10 containing “Company A” and “Company C” payment information is omitted from information 400 because they are not known by the Company B payee). Information 400 does not include qualifying information, such as tax or line item detail information. However, BIP system 103 can detect or determine which qualifying information is missing and provide the missing qualifying information (with substitute/fabricated information in an embodiment) in order to obtain a selected interchange rate to be charged to a selected payee. In another embodiment, BIP system 103 can detect common invoice payments to the same payee and aggregate the payments into one credit card transaction to have a better opportunity of obtaining a LT rate.

Information 400 may include payee information for multiple payees when a payer is providing information to a BIP system. In an embodiment, payee information may include one or more of batch number 401 (such as “404275”), payee name 402 (such as “Company A”), client payee ID 403 (such as “100168”, disbursement number 404 (such as “73500”), primary invoice 405 (such as “161745”), description 406 (such as “Terms 20 days”) and payment amount (such as a transaction amount) 407 (such as “49.69”). In an embodiment, payee information includes a payee name 402 and payment amount 407.

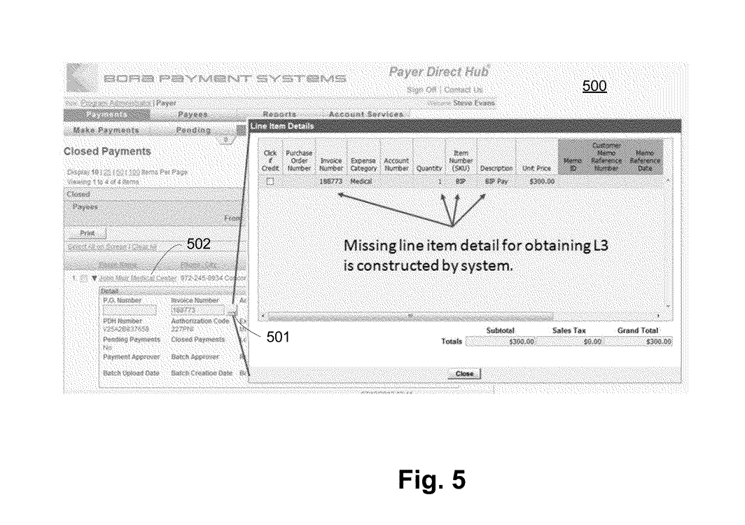

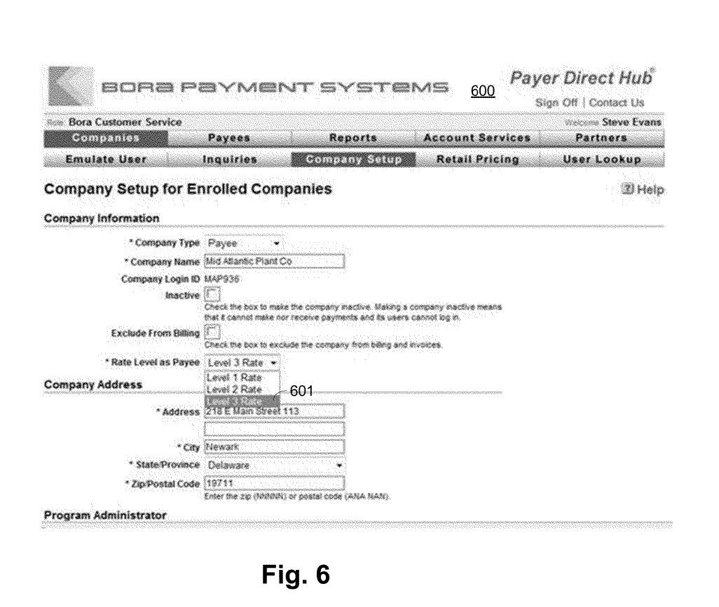

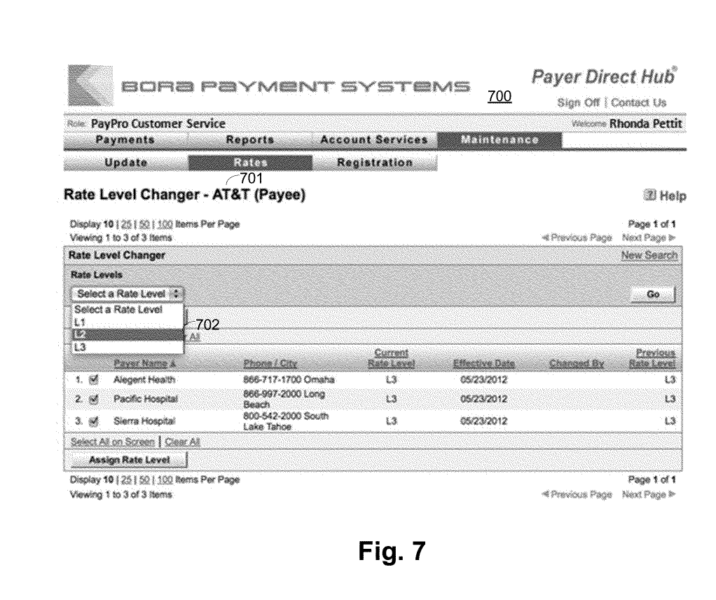

FIG. 5 depicts an exemplary user interface having a screen 500 showing substitute (or fabricated) information that replaces missing qualifying information in payee information in order to obtain a selected interchange rate. In particular, after a user selects an interchange rate to be charged a particular payee (as illustrated in FIGS. 6 and 7 by screens 600 and 700 described below), a BIP system 103 determines what information is missing to obtain the selected interchange rate and provides the missing qualifying information (or substitute/fabricated information in an embodiment). For example, screen 500 illustrates by pressing button 501 associated with invoice number “188773” that a BIP system 103 has provided the line item detail information to obtain a L3 rate for a “John Muir Medical Center” payee 502. Screen 500 illustrates how BIP system 103 provides substitute/fabricated information for missing line item detail information, such as a “1” quantity, “BIP” SKU and “BIP Pay” description. In an embodiment, screen 500, as well as other screens shown in the Figures, is provided by user interface 103a.

FIG. 6 depicts an exemplary user interface having a screen 600 for selecting an interchange rate to charge a payee. For example, in a “Company Setup for Enrolled Companies” screen 600 (or a payee's profile for each payer), a selected interchange rate to be charged a payee may be selected. Screen 600 illustrates that a “Mid Atlantic Plant Co.” payee has a “Level 3 Rate” 601 selected by way a pull-down menu. Even though a payer provides minimum payee information, a BIP system 103 provides the missing qualifying information (by way of substitute/fabricated information in an embodiment) in order to obtain the “Level 3 Rate” 601 or LT rate when the transaction amount is large enough. The substitute/fabricated information is not inserted into a batch data file from a payer, but rather dynamically created or retrieved by a BIP system 103. In an embodiment, the substitute/fabricated or missing qualifying information is included in a predetermined record or field of credit card transaction information (payment authorization request) that is provided to an acquirer processor or gateway.

FIG. 7 depicts an exemplary user interface having a screen 700 that allows a payee (rather than a payer) to select different interchange rates to be charged for different payers. In an embodiment, screen 700 is accessible by a representative of a BIP system 103 on behalf of a payer to set an interchange rate for a particular payee. In an alternate embodiment, screen 700 is accessible by both payer and payee. In still another embodiment, a payee would have access to screen 700 and no other company information. While a payee using a BIP system 103 to submit payments would be expected to always choose the lowest interchange rate, a BIP system 103 allows a payee to choose different rates for different payers as illustrated in FIG. 7. A payee might select a higher interchange rate for an important payer recognizing that a payer's issuing bank pays the payer a higher rebate if the payee pays a higher interchange rate. For example, screen 700 illustrates how a “AT&T” payee 701 selects a higher “L2” rate 702 (from the “Current Rate Level” “L3”) from a pull-down menu for “Allegent Health,” “Pacific Hospital” and “Sierra Hospital” payees.

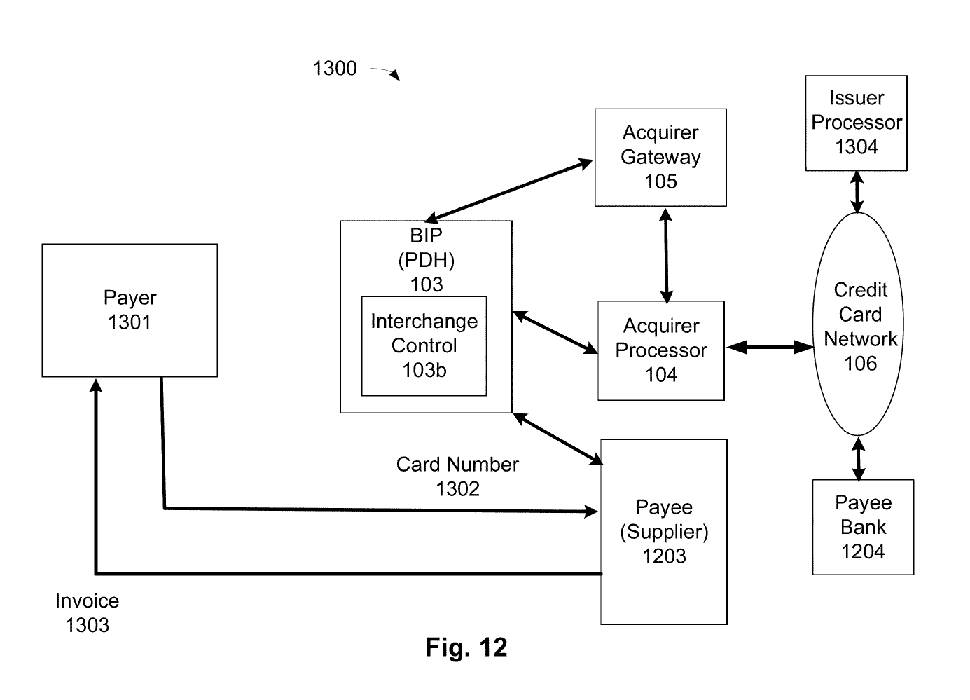

FIG. 12 depicts a block diagram illustrating a system 1300 having a payee (supplier) 1203 that uses a BIP system 103, such as a PDH, to provide qualifying information to obtain a selected interchange rate to be charged when receiving a payment from payer 1301. System 1300 includes a BIP 103 having interchange control 103b along with acquirer processor 104, acquirer gateway 105, credit card network 106 and payee bank 1204 as similarly described herein. Further, system 1300 includes issuer processor 1304 coupled to credit card network 106 as well as payee (supplier) 1203 and payer 1301.

In embodiments, a payee (supplier) 1203 uses a BIP system 103 with a Supplier-Initiated Payment (SIP) system or manual method to obtain missing qualifying information for a selected interchange rate. A SIP system or manual method provides a commercial credit card number to a payee (supplier) 1203 that uses the commercial credit card number from payer 1301. Payee (supplier) 1203 uses the provided commercial credit card number and BIP system 103 to obtain the qualifying information for a selected interchange rate. Payer 1301 may provide the commercial credit card number associated with the commercial credit card to payee (supplier) 1203 by e-mailing the commercial credit card number using a SIP system (in other embodiments, the commercial credit card number may be e-mailed without using a SIP system). In other embodiments, a commercial credit card number may be provided to payee (supplier) 1203 from payer 1301 by using a manual method, such as 1) providing the commercial credit card with an associated commercial credit card number to payee (supplier) 1203 (that then reads the commercial credit card number from the commercial credit card); 2) telephoning payee (supplier) 1203 and verbally provide the commercial credit card number; or other manual method (mail, facsimile, etc.).

For example, a payee (or supplier) 1203 may send an invoice 1303 to a payer 1301. A payer (supplier) 1203 could then use a SIP or manual method, such as a telephone, to provide a payer's commercial credit card number 1302 and payment amount to the payee (supplier) 1203. The payee (supplier) 1203 could then log into a BIP system 103 to submit the payer's commercial credit card number 1302, payment amount and invoice number without qualifying information. In an embodiment, a payee (supplier) 1203 could use a “Make Payments” screen 1100 as described herein and illustrated in FIG. 11. A “Make Payments” screen 1100 operates similar to a virtual terminal. However, a virtual terminal does not detect whether qualifying information is missing and provide the qualifying information (or substitute/fabricated information) to obtain a selected interchange rate to charge a payee (supplier) 1203. A BIP system 103 then would route a credit card transaction information to the payee's acquirer processor, such as acquirer processor 104. An acquirer processor 104 then sends authorization and settlement requests to a credit card network, such as credit card network 106, for authorization by an issuer processor, such as issuer processor 107, and settlement. A credit card network 106 then provides payment to the payee's bank account at a payee bank 1204.

In an embodiment, a BIP system 103 includes user interface 103a and interchange control 103b software components as described herein. In an embodiment, a BIP system 103 includes a web server 103c, application server 103d and database server 103e as illustrated in FIG. 10 and described herein. In an embodiment, each of a BIP system 103, acquirer processors 104, acquirer gateway 105, issuer processor 107 and credit card network 106 include at least one processor core(s) and memory to store processor readable instructions to perform the functions described herein.

In an embodiment, system 100 components communicate by way of a wired or wireless network, such as a Local Area Network (LAN), Wide Area Network (WAN) and/or the Internet.

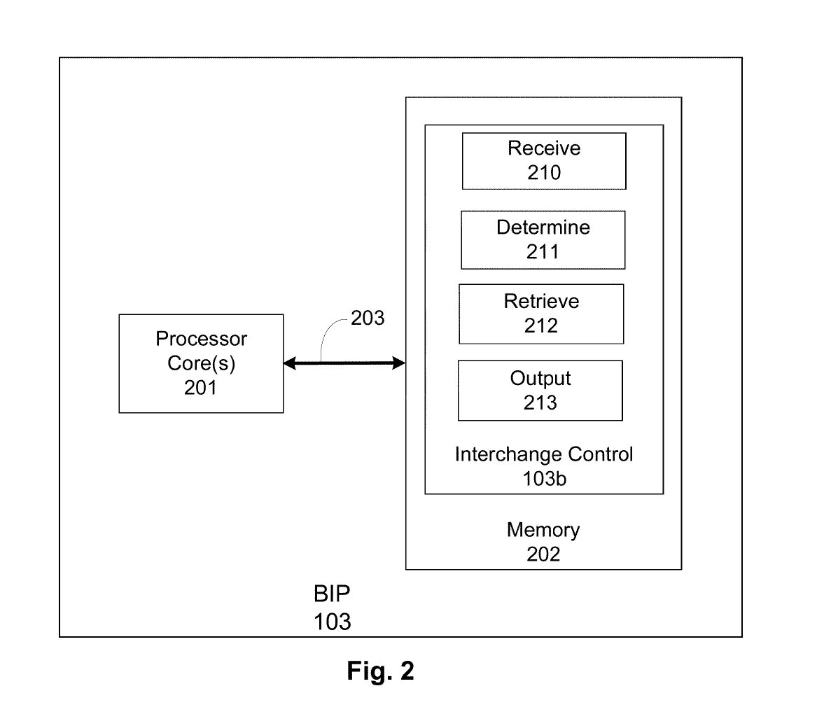

FIG. 2 depicts a block diagram illustrating one embodiment of a BIP system 103 hardware and software architecture. In an embodiment, a BIP system 103 includes at least one processor core(s) 201 and memory 202 that stores processor readable instructions. Processor core(s) 201 communicates with memory 202 by way of interconnect 203. In an embodiment, memory 202 stores software components of interchange control 103b, such as receive 210, determine 211, retrieve 212 and output 213. In an embodiment, receive 210, determine 211, retrieve 212 and output 213 are included in application server 103d as illustrated in FIG. 10.

In embodiments, a software component may include a computer (or software) program, object, function, subroutine, method, instance, script and/or processor readable instructions, or portion thereof, singly or in combination. One or more exemplary functions that may be performed by the various software components are described herein. In alternate embodiments, more or less software components and/or functions of the software components described herein may be used.

In an embodiment, receive 210 is responsible for at least receiving and storing payee information that may be provided by a payer. In an embodiment, payee information may be entered by way or a user interface as described herein or may be provided by an electronic file. In embodiments, payee information may include information illustrated in FIG. 4, or a portion thereof. In an embodiment, payee information is stored in database server 103e.

In an embodiment, determine 211 is responsible for determining or detecting whether the payee information has qualifying information, such as tax information and/or line item detail information, for a selected interchange rate to be charged a payee. In an embodiment, a selected interchange rate for a payee may be entered by way of a user interface as described herein or may be provided by an electronic file. For example, an interchange rate may be selected by a user making selections at a user interface having radio buttons or drop-down selections as illustrated in FIGS. 6 and 7. In an embodiment, selected interchange rates are stored with associated payees in database server 103e.

In an embodiment, retrieve 212 is responsible for retrieving (or substituting/fabricating) missing qualifying information (or substitute/fabricate information), such as tax information and/or line item detail information, for a selected interchange rate to be charged a payee. In an embodiment, retrieve 212 substitutes missing qualifying information with substitute/fabricated information that is not tax information and/or line item detail information. In an embodiment, substitute information is dynamically constructed. In an embodiment, the substitute information may be dynamically fabricated information, such as a series of zeroes or dummy characters (or similar characters) that fill corresponding fields in a credit card payment transaction information. The qualifying information may be replaced with substitute/fabricated information that is not accurate qualifying information since the qualifying information is already known by a payer and payee and not used. Retrieve 212 retrieves qualifying or substitute/fabricated information from memory 202 and inserts the qualifying or substitute/fabricated information into commercial credit card transaction information, such as s commercial credit card authorization or payment request. In an embodiment, qualifying information and/or substitute/fabricated information is stored with associated payees in database server 103e having a processor readable memory.

In an embodiment, output 213 is responsible for outputting commercial credit card transaction information with the payee information and missing qualifying information (or substitute/fabricated information) in order to obtain a selected interchange rate for a payee. In an embodiment, output 213 outputs a commercial credit card transaction information to acquirer gateway 105 or acquirer processor 104. In an embodiment, output 213 is includes in and/or utilizes application server 103d.

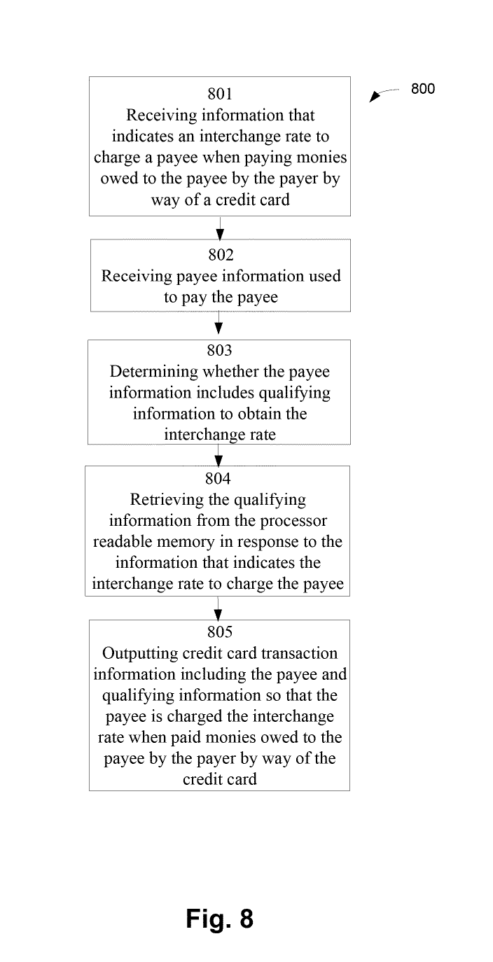

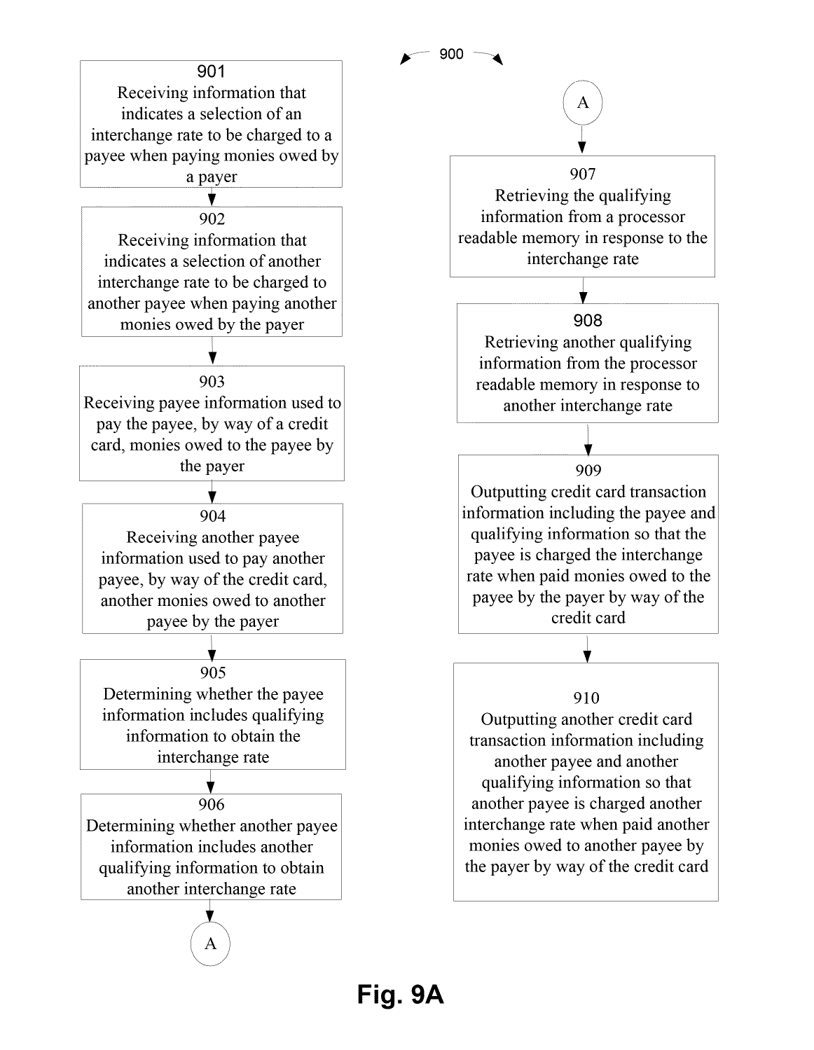

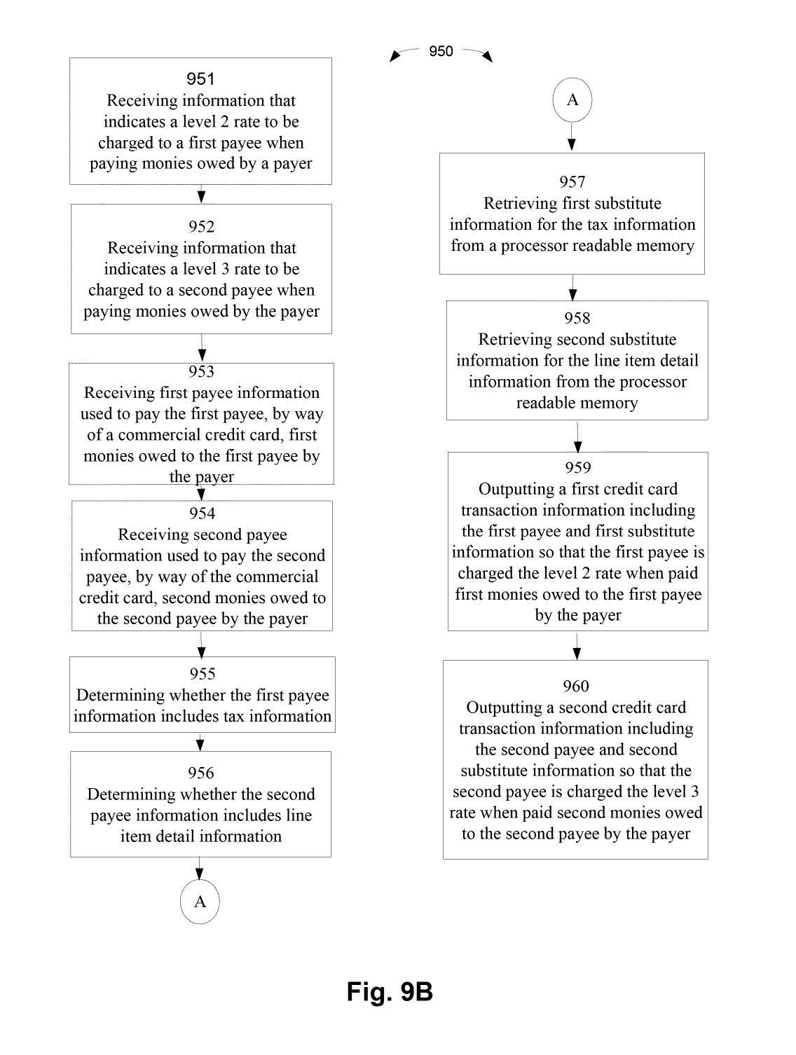

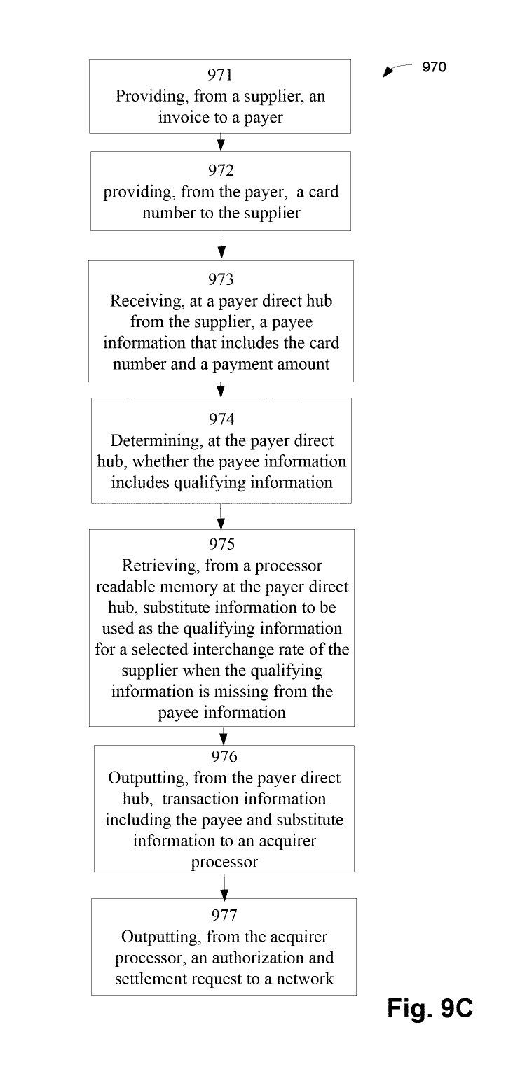

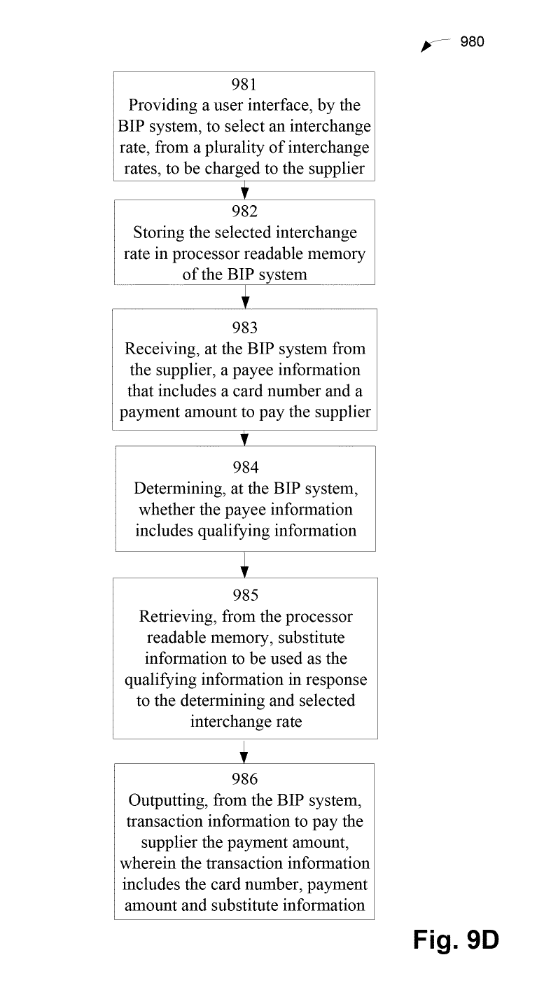

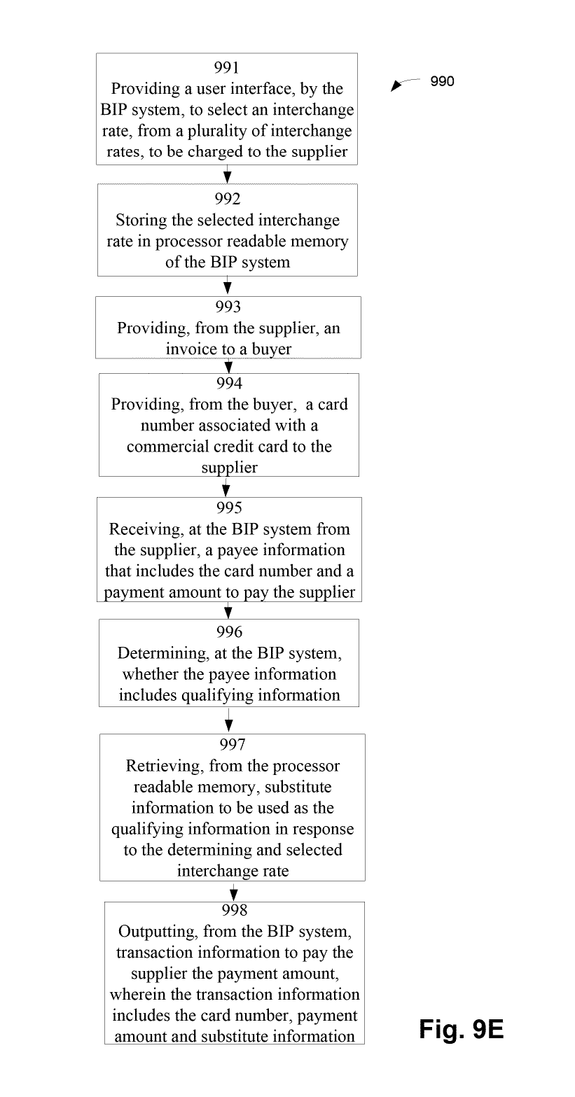

FIGS. 8 and 9A-E depict flow diagrams displaying exemplary methods for facilitating a commercial credit card transaction by selecting an interchange rate to charge a payee and providing missing qualifying information. Method 800 begins at logic block 801 illustrating receiving information that indicates an interchange rate to charge a payee when paying monies owed to the payee by the payer by way of a commercial credit card. In an embodiment, user interface 103a executed by processor core(s) 201 performs at least a portion of the function illustrated by logic block 801.

Logic block 802 illustrates receiving payee information used to pay the payee. In an embodiment, receive 210 executed by processor core(s) 201 performs at least a portion of the function illustrated by logic block 802.

Logic block 803 illustrates determining whether the payee information includes qualifying information to obtain the interchange rate. In an embodiment, determine 211 executed by processor core(s) 201 performs at least a portion of the function illustrated by logic block 803.

Logic block 804 illustrates retrieving the qualifying (or substitute/fabricated) information from the processor readable memory in response to the information that indicates the interchange rate to charge the payee. In an embodiment, retrieve 212 executed by processor core(s) 201 performs at least a portion of the function illustrated by logic block 804.

Logic block 805 illustrates outputting credit card transaction information including the payee and qualifying (substitute/fabricated) information so that the payee is charged the interchange rate when paid monies owed to the payee by the payer by way of the credit card. In an embodiment, the retrieved and outputted qualifying information is substitute information. In an embodiment, output 213 executed by processor core(s) 201 performs at least a portion of the function illustrated by logic block 805.

FIGS. 9A-B illustrate methods 900 and 950 according to embodiments. Method 900 begins at logic block 901 illustrating receiving information that indicates a selection of an interchange rate to be charged to a payee when paying monies owed by a payer.

Logic block 902 illustrates receiving information that indicates a selection of another interchange rate to be charged to another payee when paying another monies owed by the payer.

Logic block 903 illustrates receiving payee information used to pay the payee, by way of a commercial credit card, monies owed to the payee by the payer

Logic block 904 illustrates receiving another payee information used to pay another payee, by way of the commercial credit card, another monies owed to another payee by the payer.

Logic block 905 illustrates determining whether the payee information includes qualifying information to obtain the interchange rate.

Logic block 906 illustrates determining whether another payee information includes another qualifying information to obtain another interchange rate.

Logic block 907 illustrates retrieving the qualifying (substitute/fabricated) information from a processor readable memory in response to the interchange rate.

Logic block 908 illustrates retrieving another qualifying (substitute/fabricated) information from the processor readable memory in response to another interchange rate.

Logic block 909 illustrates outputting credit card transaction information including the payee and qualifying (substitute/fabricated) information so that the payee is charged the interchange rate when paid monies owed to the payee by the payer by way of the credit card.

Logic block 910 illustrates outputting another credit card transaction information including another payee and another qualifying (substitute/fabricated) information so that another payee is charged another interchange rate when paid another monies owed to another payee by the payer by way of the credit card. In an embodiment, the retrieved and outputted qualifying information is substitute information.

Method 950 begins at logic block 951 illustrating receiving information that indicates a Level 2 rate to be charged to a first payee when paying monies owed by a payer.

Logic block 952 illustrates receiving information that indicates a Level 3 rate to be charged to a second payee when paying monies owed by the payer.

Logic block 953 illustrates receiving first payee information used to pay the first payee, by way of a commercial credit card, first monies owed to the first payee by the payer.

Logic block 954 illustrates receiving second payee information used to pay the second payee, by way of the commercial credit card, second monies owed to the second payee by the payer.

Logic block 955 illustrates determining whether the first payee information includes tax information.

Logic block 956 illustrates determining whether the second payee information includes line item detail information.

Logic block 957 illustrates retrieving first substitute information for the tax information from a processor readable memory.

Logic block 958 illustrates retrieving second substitute information for the line item detail information from the processor readable memory.

Logic block 959 illustrates outputting a first credit card transaction information including the first payee and first substitute information so that the first payee is charged the Level 2 rate when paid first monies owed to the first payee by the payer.

Logic block 960 illustrates outputting a second credit card transaction information including the second payee and second substitute information so that the second payee is charged the Level 3 rate when paid second monies owed to the second payee by the payer.

FIGS. 9C-E depict flow diagrams displaying exemplary methods of suppliers using a BIP system, such a PDH. Method 970 illustrated in FIG. 9C begins at logic block 971 illustrating providing, from a supplier, an invoice to a payer.

Logic block 972 illustrates providing, from the payer, a card number to the supplier.

Logic block 973 illustrates receiving, at a payer direct hub from the supplier, a payee information that includes the card number and a payment amount.

Logic block 974 illustrates determining, at the payer direct hub, whether the payee information includes qualifying information.

Logic block 975 illustrates retrieving, from a processor readable memory at the payer direct hub, substitute information to be used as the qualifying information for a selected interchange rate of the supplier when the qualifying information is missing from the payee information.

Logic block 976 illustrates outputting, from the payer direct hub, transaction information including the payee and substitute information to an acquirer processor.

Logic block 977 illustrates outputting, from the acquirer processor, an authorization and settlement request to a network.

Method 980, shown in FIG. 9D, begins at logic block 981 illustrating providing a user interface, by the BIP system, to select an interchange rate, from a plurality of interchange rates, to be charged to the supplier.

Logic block 982 illustrates storing the selected interchange rate in processor readable memory of the BIP system.

Logic block 983 illustrates receiving, at the BIP system from the supplier, a payee information that includes a card number and a payment amount to pay the supplier.

Logic block 984 illustrates determining, at the BIP system, whether the payee information includes qualifying information.

Logic block 985 illustrates retrieving, from the processor readable memory, substitute information to be used as the qualifying information in response to the determining and selected interchange rate.

Logic block 986 illustrates outputting, from the BIP system, transaction information to pay the supplier the payment amount, wherein the transaction information includes the card number, payment amount and substitute information.

Logic block 987 illustrates outputting, from the acquirer processor, an authorization and settlement request to a network.

Method 990, shown in FIG. 9E, begins at logic block 991 illustrating providing a user interface, by the BIP system, to select an interchange rate, from a plurality of interchange rates, to be charged to the supplier.

Logic block 992 illustrates storing the selected interchange rate in processor readable memory of the BIP system.

Logic block 993 illustrates providing, from the supplier, an invoice to a buyer.

Logic block 994 illustrates providing, from the buyer, a card number associated with a commercial credit card to the supplier.

Logic block 995 illustrates receiving, at the BIP system from the supplier, a payee information that includes the card number and a payment amount to pay the supplier.

Logic block 996 illustrates determining, at the BIP system, whether the payee information includes qualifying information.

Logic block 997 illustrates retrieving, from the processor readable memory, substitute information to be used as the qualifying information in response to the determining and selected interchange rate.

Logic block 998 illustrates outputting, from the BIP system, transaction information to pay the supplier the payment amount, wherein the transaction information includes the card number, payment amount and substitute information.

FIG. 10 illustrates a commercial credit card payment system 1000. The system 1000 generally includes a BIP system 103, an acquirer processor 104, an acquirer gateway 105, issuer processor 107 and a credit card network 106. In an embodiment, a payee accesses a BIP system 103 instead of payer 1004 to facilitate commercial credit card payments as described herein. In an alternate embodiment, a BIP system 103 facilitates a method for processing commercial credit card payments between a payer 1004 and multiple payees. In an alternate embodiment, a BIP system 103 allows a payer 1004 to schedule multiple commercial credit card payments to multiple payees for monies owed by the payer through a single user interface.

In an alternate embodiment, a BIP system 103 receives an electronic AP payment file from a payer rather than having a payer use a single user interface to enter the information for commercial credit card payments. In an embodiment, application server 103d receives an electronic AP payment file via Secure File Transport Protocol (SFTP) or Applicability Statement 2 (AS2) protocol.

In an embodiment in which a payee uses a BIP system 103, a payee may upload or provide an electronic payment file to a BIP system 103 for the payee's own payments to a payer. In an embodiment, an electronic payment file may include information for a single payee (submitted by the payee) as illustrated by portions of FIG. 4 (For example, Company B information when the payee is Company B).

BIP system 103 is a BIP system as opposed to pull payment system (also refer as SIP system). Pull or SIP systems generally send an email to a payee and a payee either uses a ghost card number (no plastic) provided by a payer or they use a single-use number (used once and invalid afterward) to submit the payment to their own acquirer processor. In pull or SIP systems, the payee is not passive as with a BIP system and the payee must submit the payment. The payment may also decline, in which case the payee must notify the payer and the payer must rectify the card problem and either re-issue a new single-use card number (for single-use card systems) or tell the payee to re-submit the transaction if they have given the payee a ghost card number (re-usable number that is often reduced to a zero balance once the invoice is paid). Pull (or SIP) systems require significantly more A/R labor; can result in declines; and are slower to settle since they are delivered by email. A pull system cannot influence the interchange rate since the systems don't actually submit the payment for the payee. The authorization origination is via the payee and not the payer.

A BIP system 103 in FIG. 10 communicates with either the acquirer processor 104 or an acquirer gateway 105. As used herein in an embodiment, an acquirer processor refers to the acquirer bank in a credit card transaction. In an embodiment, an acquirer processor also includes an apparatus having a processor core(s) and memory that stores processor readable instruction that perform one or more of the functions as described herein. In an embodiment, an acquirer bank is the payee's merchant bank and typically has the liability associated with the merchant's (payee) behavior in a transaction. Often the acquirer bank has a service contract with a service company to perform the acquirer function of routing credit card transaction information, such as authorizations, settlements, and chargebacks, for an acquirer bank on behalf of a payee. In an embodiment, a service company is referred to herein as an acquirer processor 104. An acquirer processor 104 shown in FIG. 10 is an intermediary or service bureau that provides a single point of access to various payment networks. For example, an acquirer processor 104 may provide access to credit card networks such as Visa, MasterCard, Discover, American Express, Diner's Card, and the like networks.

An acquirer gateway 105 is an intermediary or service bureau that provides a single point of access to various acquirer processors 104 in embodiments. Exemplary acquirer gateways include Cybersource, PayPal's PayFlowPro. Pay-Me-Now. and Authorize.net. In an embodiment, an acquirer gateway also includes an apparatus having a processor core(s) and memory that stores processor readable instruction that perform one or more of the functions as described herein.

In an embodiment, a BIP system 103 comprises a web server 103c, an application server 103d, a database server 103e, an email server 1116 and a report server 1118. Each of these servers includes one or more processor core(s) in communication with memory and one or more communication interfaces (e.g., network interface, wireless interface, etc.).

FIG. 10 illustrates that a payer 1004 or payee that accesses a web server 103c through a browser 1120. A web server 103c, among other things, facilitates communication (e.g., Secure Socket Layer (SSL), Hypertext Transport Protocol Secure (HTTPS)) between a payer/payee and their browsers and the application server 103d and provides a user interfaces (described herein) that enables payer and payees to communicate with a BIP system 103 via a standard web browser.

An application server 103d performs many functions. By way of example only, an application server 103d provides data to the web server 103c for presentation to the payers, adds data to, updates, and retrieves data from the database server 103e, enforces business logic, communicates with an acquirer processor or acquirer gateway web servers via a secure channel (e.g., SSL/HTTPS) for the authorization and settlement of payment instructions, and provides email requests to an email server 1116 for the broadcasting of email alerts to payers.

In an embodiment, database server 103e includes memory having a database. In another embodiment, application server 103d and a database server 103e may be the same server. In an embodiment, web-server 103c is isolated outside a firewall for security purposes.

A database server 103e may, among other things, store payer and payee user information (merchant information), credit card information (e.g., credit card number, statement end date, etc.), qualifying information, substitute/fabricated information, selected interchange rates for payees and information related to the payment instructions, responds to data updates and data retrieval from an application server 103d and delivers data to report server 1118 when requested. An email server 1116 manages the transmission of email notifications generated by an application server 103d and sent to the payer. A report server 1118 generates reports that can be accessed by either a payer or a payee.

An exemplary operation of BIP system 103 is described below. Either a payer or payee may operate a BIP system 103. While the following paragraphs describe the operation of a payer, a payee may similarly operate a BIP system 103. For example, a payee may receive a payee ID (company ID), login ID (individual ID) and a password as described herein. Suppose a payer is an employee of Company A and Company A issued a payer a company commercial credit card. In one embodiment, a payer 1004 registers with a BIP system 103 and obtains a unique payer ID (company ID), a login ID (individual ID) and a password. To insure a second level of security, a payer may install a digital certificate obtained from a BIP system 103. A BIP system 103 may also collect from the payer 1004 company and individual data such as a physical address and email address.

A payer, after registering, may register a payee by creating a payee profile that includes, among other things, the payee's Merchant ID (MID) and processing platform name. A payee's processing platform may comprise either an acquirer processor 104 or an acquirer gateway 105. When a payer adds sufficient information on a payee (MID, processing platform, payee address, etc.) necessary to route payment instructions (in credit card transaction information) to a payee, a payee should be considered registered in a BIP system 103 but not enrolled. A payee is enrolled when at least one person (e.g., employee of payee) is approved for the purposes of logging into a BIP system 103 and accessing screens. In one embodiment, a payee is assigned a payee ID. Using a payee ID, a payee may access a BIP system 103 and view only the reports and queues that a payer has authorized a payee to view (e.g., pending payments queues described in more detail later). In an embodiment, a BIP system operator and/or a registration agent, such as an ISO for an acquirer processor, registers payees as described herein.

FIG. 11 illustrates an exemplary Make Payments screen 1100 that may be provided by a BIP system 103 in order to allow a payer to schedule payments to one or more payees. In an embodiment, a payee may use Make Payments screen 1100 (as described herein for a payer) to schedule payments or enter payee information so that the payee is paid by a payer by way of a commercial credit card. The scheduled payments are for monies owed by a company that will be paid for by an employee on his issued commercial credit card. The Make Payments screen 1100 includes that allows a payer 1004 to schedule a commercial credit card payment to one or more payees. A payer 1004 schedules each payment request by designating, by way of example only, a payment account (commercial credit card to charge), a submit date (a date to charge a commercial credit card), a charge amount (an amount to charge a commercial credit card), a purchase order number, and an invoice number. For example, in FIG. 11, a payer 1004 is scheduling a payment request to pay for monies owed to three payees: AT&T 1104, Comcast 1122 and Office Depot 1140.

A payer 1004 schedules a payment request to AT&T 1104 by entering in payment data in screen 1100. For example, a payer 1004 has selected to charge the money owed to AT&T 1104 to the commercial credit card designated as “MasterCard 4444” 1106 in a drop-down menu. The credit card numbers available in a drop-down menu represents the commercial credit cards that a payer is authorized to use. At a minimum, a payer 1004 also enters a date to charge “MasterCard 4444” in a Submit On window 1108 and an amount to charge “MasterCard 4444” in the Amount window 1110. If that is all the information a payer 1004 intends to include in a payment request to AT&T 1104, payer 1004 may select a Make Payment button 1120.

To aid in tracking the payment to AT&T 1104, the payer 1104 may also enter a purchase order number in the Purchase Order (P.O.) Number window 1112 and enter an invoice number in the Invoice Number window 1114 before selecting the Make Payment button 220. In an embodiment, this information is not required.

A payer 1104 may also schedule payment requests to Comcast 1122 and Office Depot 1140 before selecting a Make Payment button. To schedule a payment request to Comcast 1122, a payer 1004 designates a payment account 1124, Submit On date 1126 and charge amount 1128. A payer 1004 may also want to add a purchase order number in a P.O. Number window 1130 and an invoice number in an Invoice Number window 1132 for tracking purposes. After a payment request to Comcast 222 has been entered, a Payer 1004 may select a Make Payment button 1138.

To schedule a payment request to Office Depot 1140, a payer designates a payment account 1142, Submit On date 1146 and amount 1148. A Payment Account window 1142 is shown as a drop-down menu containing two accounts: “MasterCard 4444” and “Visa 1111.” Such a drop-down menu limits the account choices provided to a payer and prevents having to enter the entire account number every time a payment request is scheduled. To assist in tracking a payment to Office Depot 1140, a payer 1004 may also enter the purchase order number in the P.O. Number window 1150 and an invoice number in an Invoice Number window 1152. After the payment information to Office Depot 1140 has been entered, a payer 1004 may select the Make Payment button 1158.

Upon selecting a Make Payment button, a BIP system 103 generates payment instructions based on the payment data entered for the specific payee. For example, a BIP system 103 generates payment instructions based on the payment data to AT&T 1104 when a payer 1004 selects a Make Payment button 1120. A BIP system 103 generates payment instructions based on the payment data to Comcast 1122 when a payer 1004 selects a Make Payment button 1138, and so on. Each of the payment instructions or payment request comprise a set of data required to process the payment to a payee as a single commercial credit card transaction. In a FIG. 11 embodiment, a BIP system 103 will generate three separate payment instructions: payment instructions for AT&T 1104, payment instructions for Comcast 1122 and payment instructions for Office Depot 1140. A BIP system 103 stores each of the payment instructions in a pending payment queue.

Unlike a conventional credit card business model where a payer would have to log onto an Office Depot website and an AT&T website individually and enter credit card information, a payer, using a BIP system 103, logs onto a single website or user interface to schedule both of these payments.

A BIP system 103 will manage processing of all payment requests either entered manually through a Make Payments screen 1100 or uploaded via an electronic AP payment file or electronic file from a payee. Unlike a conventional bill pay system where a payment request would be converted to a Demand Deposit Account (DDA) transfer, a check, and so on, to pay for monies owed, a BIP system 103 will transact each of the scheduled payment requests as a commercial credit card transaction.

In an embodiment, a BIP system 103 provides a user interface that allows a payer 1004 (or payee) to view pending payment requests. In another embodiment, BIP system 103 provides a user interface to edit pending payments and/or warn that a credit card was previously declined.

In an embodiment, a BIP system 103 provides a user interface that displays declined payments and an interface to resubmit declined payments.

In another embodiment, a BIP system 103 may communicate with multiple acquirer processors and/or multiple acquirer gateways.

Acquirer processor, in an embodiment, refers to an acquirer bank in a credit card transaction. An acquirer bank is a payee's merchant bank and has the liability associated with the payee's (merchant) behavior in a transaction.

An acquirer processor, in an alternate embodiment, refers to a service company. Often an acquirer bank has a service contract with a service company such as FDC or Tsys to perform the acquirer function of routing credit card authorizations, settlements, and chargebacks for the acquirer bank on behalf of the payee (merchant).

Issuer bank, in an embodiment, refers to a bank that issues a commercial credit card to a payer.

Buyer or payer, in an embodiment, refers to a corporation or government entity that is using a commercial credit card to pay an invoice.

A commercial credit card including a Pcard and other B2B credit cards, in embodiments, are credit cards that facilitate business to business accounts payable. They may be used to pay for travel and entertainment expense. They may have specific Bank Identification Numbers (BINs) issued by Visa and MasterCard that are used for B2B payments between corporations and government entities. They may have spending control restrictions (parameters) and features not found with consumer or business cards.

A MID, in an embodiment, refers to a unique credit card routing number issued by an acquirer processor (or their agent or service company) to a payee for receiving a commercial credit card transaction. The number is associated with a deposit account where funds will be deposited. MIDs are often associated with a POS terminal device or a virtual terminal software application. A MID uniquely identifies a payee to a credit card network and participating parties. Many companies have multiple MIDs.

Payee, merchant or supplier, in embodiments, refers to a corporation or entity who provides products or services and who generates an invoice to be paid for the products or services. Often suppliers are referred to as merchants, particularly by an acquirer processors and merchant banks.

In embodiments, processor core(s) 201 as illustrated in FIG. 2 includes at least one processor core that executes (or reads) processor (or machine) readable instructions stored in processor readable memory. An example of processor readable instructions may include receive 210, determine 211, retrieve 212 and output 213 software components shown in FIG. 2.

In embodiments, memory 202 as illustrated in FIG. 1 may be volatile and/or non-volatile processor (machine) readable memory, or a combination thereof. Types of volatile memory include, but are not limited to, dynamic random access memory (DRAM), molecular charge-based (ZettaCore) DRAM, floating-body DRAM and static random access memory (“SRAM”).

Types of non-volatile memory include, but are not limited to, types of electrically erasable program read-only memory (“EEPROM”), FLASH (including NAND and NOR FLASH), ONO FLASH, magneto resistive or magnetic RAM (“MRAM”), and ferroelectric RAM (“FRAM”).

In an embodiment, at least portions receive 210, determine 211, retrieve 212 and output 213 are stored in memory, such as a hard disk drive. When an apparatus, such as a BIP system 103, is powered on, various portions of receive 210, determine 211, retrieve 212 and output 213 (as well as user interface 103a) are loaded into memory 202 for execution by processor core(s) 201. In embodiments other applications can be stored on the hard disk drive for execution by processor core(s) 201.

The flowcharts and block diagrams in the Figures illustrate the architecture, functionality, and operation of possible implementations of systems (apparatus), methods and a computer (software) programs, according to embodiments. In this regard, each block in the flowchart or block diagram may represent a software component. In an embodiment, each block in a flowchart may represent at least a processor core(s) executing processor readable instructions in a software component stored in processor readable memory to perform at least a portion of a function described in a block. It should also be noted that, in some alternative implementations, the functions noted in a block may occur out of the order noted in the Figures. For example, two blocks shown in succession may, in fact, be executed substantially concurrently, or blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and software components.

In embodiments, illustrated and/or described signal paths are media that transfers a signal or information. In an embodiment, multiple signal paths may replace a single signal path illustrated in the Figures and a single signal path may replace multiple signal paths illustrated in the Figures. In embodiments, signal paths are unidirectional (signals that travel in one direction) or bidirectional (signals that travel in two directions) or combinations of both unidirectional signal lines and bidirectional signal lines.

The foregoing detailed description has been presented for purposes of illustration and description. It is not intended to be exhaustive or to limit the inventive system to the precise form disclosed. Many modifications and variations are possible in light of the above teaching. As used herein, the singular forms “a”, “an” and “the” are intended to include the plural forms as well, unless the context clearly indicates otherwise. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

I claim:

1. A method comprising:
providing, from a supplier, an invoice to a payer;
providing, from the payer, a card number to the supplier;
receiving, at a payer direct hub from the supplier, a payee information that includes the card number and a payment amount;
determining, at the payer direct hub, whether the payee information includes a qualifying information;
retrieving, from a processor readable memory at the payer direct hub, substitute information to be used as the qualifying information for a selected interchange rate of the supplier when the qualifying information is missing from the payee information;
outputting, from the payer direct hub, transaction information including the payee and substitute information to an acquirer processor; and,
outputting, from the acquirer processor, an authorization and settlement request to a network.

2. The method of claim 1, wherein the providing, from the payer, the card number to the supplier includes the payer using a supplier-initiated payment (SIP) system to provide the card number.

3. The method of claim 2, wherein the payer uses a SIP system to provide an e-mail including the card number to the supplier.

4. The method of claim 1, wherein the providing, from the payer, the card number to the supplier includes providing the card number using a telephone.

5. The method of claim 1, wherein the interchange rate is selected from a fixed amount and a percentage of monies owed the supplier.

6. The method of claim 1, wherein receiving, at the payer direct hub from the supplier, the payee information includes the supplier logging into the payer direct hub and entering the card number and the payment amount.

7. The method of claim 6, wherein the entering the card number and the payment amount includes entering the card number and the payment amount at a make payments screen.

8. The method of claim 1, wherein the acquirer processor is an acquirer processor of the supplier, wherein the card number is associated with a commercial credit card, wherein the network includes a credit card network, and wherein the payer direct hub includes a buyer-initiated payment system.

9. The method of claim 1, wherein the substitute information includes fabricated information.

10. The method of claim 1, wherein the qualifying information includes tax information.

11. The method of claim 10, wherein the qualifying information further includes line item detail information.

12. The method of claim 1, wherein the interchange rate is a percentage of the payment amount that is charged to the supplier when using a commercial credit card associated with the card number.

13. The method of claim 12, wherein the interchange rate that is charged to the supplier is included in a total fee selected from one of a Level 1, Level 2 and Level 3 rate.

14. A method to operate a buyer-initiated payment (BIP) system used by a supplier, the method comprising:
providing a user interface, by the BIP system, to select an interchange rate, from a plurality of interchange rates, to be charged to the supplier;
storing the interchange rate in processor readable memory of the BIP system;
receiving, at the BIP system from the supplier, a payee information that includes a card number and a payment amount to pay the supplier;
determining, at the BIP system, whether the payee information includes qualifying information;
retrieving, from the processor readable memory, substitute information to be used as qualifying information in response to the determining and interchange rate; and
outputting, from the BIP system, transaction information to pay the supplier the payment amount, wherein the transaction information includes the card number, payment amount and substitute information.

15. The method of claim 14, wherein the transaction information includes a credit card transaction information, wherein the card number is associated with a commercial credit card and wherein the outputting includes outputting the credit card transaction information to an acquirer processor of the supplier, the acquirer processor coupled to a credit card network.

16. The method of claim 14, wherein the qualifying information is selected from tax information and tax information and line item detail information, and wherein the interchange rate is included in a total fee charged to the supplier selected from one of a Level 1, Level 2 and Level 3 rate.

17. The method of claim 14, wherein substitute information is fabricated information.

18. A method to operate a buyer-initiated payment (BIP) system used by a supplier, the method comprising:
providing a user interface, by the BIP system, to select an interchange rate, from a plurality of interchange rates, to be charged to the supplier;
storing the interchange rate in processor readable memory of the BIP system;
providing, from the supplier, an invoice to a buyer;
providing, from the buyer, a card number associated with a commercial credit card to the supplier;
receiving, at the BIP system from the supplier, a payee information that includes the card number and a payment amount to pay the supplier;
determining, at the BIP system, whether the payee information includes qualifying information;
retrieving, from the processor readable memory, substitute information to be used as qualifying information in response to the determining and interchange rate; and
outputting, from the BIP system, transaction information to pay the supplier the payment amount, wherein the transaction information includes the card number, payment amount and substitute information.

19. The method of claim 18, wherein the providing, from the buyer, the card number associated with the commercial credit card to the supplier includes the buyer using a supplier-initiated payment (SIP) system to provide the card number by way of e-mail.

20. The method of claim 18, wherein the providing, from the buyer, the card number associated with the commercial credit card to the supplier includes the buyer telephoning the supplier to provide the card number.

21. The method of claim 18, where in the interchange rate is selected from a fixed amount and a percentage of monies owed the supplier.

22. The method of claim 18, wherein the qualifying information is selected from tax information and tax as well as line item detail information, and wherein the interchange rate is included in a total fee charged to the supplier selected from one of a Level 1, Level 2 and Level 3 rate.

23. The method of claim 18, wherein the substitute information is fabricated information.
